(19) United States
(12) Patent Application Publication
(10) Pub. No.: US 2022/0388674 A1
(43) Pub. Date: Dec. 8, 2022

(54) METHODS AND SYSTEMS FOR ALERTING DYNAMIC CHANGES IN FLIGHT RULES

(71) Applicant: HONEYWELL INTERNATIONAL INC., Charlotte, NC (US)

(72) Inventors: Sivakumar Kanagarajan, Bangalore (IN); Gobinathan Baladhandapani, Madurai (IN); Hariharan Saptharishi, Madurai (IN)

(73) Assignee: HONEYWELL INTERNATIONAL INC., Charlotte, NC (US)

(21) Appl. No.: 17/305,477

(22) Filed: Jul. 8, 2021

(30) Foreign Application Priority Data
May 25, 2021 (IN) 202111023237

(51) Int. Cl. B64D 45/00; G08G 5/00; B64D 43/00

(52) U.S. Cl. CPC B64D 45/00; G08G 5/0039; G08G 5/0004; G08G 5/0017; B64D 43/00; B64D 2045/0075

(57) ABSTRACT

Methods and systems for providing alerts in an aircraft. The methods and systems receive a flight plan and conditions data providing information on flight conditions along the flight plan including meteorological data. The conditions data is analyzed in flying regions along the flight plan to determine flight rules information. An alert is output to flight crew of the aircraft. The alert predicts when and where a change between type of flight rules will occur based on the flight rules information.

### CROSS REFERENCE TO RELATED APPLICATION

The present application claims benefit of prior filed Indian Provisional Patent Application No. 202111023237, filed May 25, 2021, which is hereby incorporated by reference herein in its entirety.

### TECHNICAL FIELD

The subject matter described herein relates to alerts provided to flight crew based on a type of flying rules in place.

### BACKGROUND

Visual Flight Rules (VFR) require a pilot to be able to see outside the cockpit when navigating the aircraft and avoiding obstacles and other aircraft. Under visual meteorological conditions (VMC), the minimum visual range, distance from clouds, or cloud clearance requirements to be maintained above ground vary by jurisdiction, and may also vary according to the airspace in which the aircraft is operating.

Some Air Traffic Control (ATC) operations will provide “pop-up” Instrument Flight Rules (IFR) clearances for aircraft operating VFR but that are arriving at an airport that does not meet VMC requirements. For example, in the United States, California's Oakland (KOAK), Monterey (KMRY) and Santa Ana (KSNA) airports routinely grant temporary IFR clearance when a low coastal overcast forces instrument approaches, while the rest of the state is still under visual flight rules.

For instance, a small cloud forming over an airport at less than 1000 feet technically requires the airport to allow only IFR flights using instrument approaches/departures. A VFR flight intending to land there would normally be denied clearance, and would either have to divert to another field with VMC, or declare an emergency and override the denial of clearance, which can prompt an inquiry and possibly result in adverse consequences for the pilot. To avoid these scenarios, VFR flights intending to land at or take off from an airport experiencing localized conditions marginally below VMC minima may request Special VFR clearance from the tower.

IFR permits an aircraft to operate in instrument meteorological conditions (IMC), which is essentially any weather condition less than VMC but in which aircraft can still operate safely. Use of instrument flight rules is also required when flying in “Class A” airspace regardless of weather conditions. Flight in Class A airspace requires pilots and aircraft to be instrument equipped and rated and to be operating under Instrument Flight Rules (IFR). Instrument pilots must meticulously evaluate weather, create a very detailed flight plan based around specific instrument departure, en route, and arrival procedures, and dispatch the flight. There are various scenarios when pilots encounter VFR or IFR or other categories of flying rules and they have to make the decisions based on available information.

Flights operating under visual flight rules (VFR) flying into instrument meteorological conditions (IMC) remains a prominent safety issue as Pilots can fail to judge the IMC conditions during the flight due to the weather dynamics.

Accordingly, it is desirable to provide methods and systems to improve situational awareness concerning flying rules, and actions to be taken that are associated with flying rules, for a flight plan. Furthermore, other desirable features and characteristics of the present invention will become apparent from the subsequent detailed description and the appended claims, taken in conjunction with the accompanying drawings and the foregoing technical field and background.

### BRIEF SUMMARY

In one aspect, the present disclosure provides methods and systems for providing alerts in an aircraft. The methods and systems receive a flight plan and conditions data providing information on flight conditions along the flight plan including meteorological data. The conditions data is analyzed in flying regions along the flight plan to determine flight rules information. An alert is output to flight crew of the aircraft. The alert predicts when and where a change between type of flight rules will occur based on the flight rules information.

### BRIEF DESCRIPTION OF THE DRAWINGS

Embodiments of the subject matter will hereinafter be described in conjunction with the following drawing figures, wherein like numerals denote like elements, and:

FIG. 1 is a block diagram of an aircraft system for providing flight rules alerts, in accordance with an exemplary embodiment;

FIG. 2 depicts an exemplary graphical display including flight rules alerts, in accordance with an exemplary embodiment;

FIG. 3 depicts another exemplary another exemplary display including flight rules alerts, in accordance with an exemplary embodiment;

FIG. 4 is a flowchart of a method for providing flight rules alerts, in accordance with an embodiment; and

FIG. 5 depicts an exemplary embodiment of an aircraft system suitable for implementing the systems and methods for providing flight rules alerts, in accordance with one or more embodiments.

### DETAILED DESCRIPTION

Embodiments of the subject matter described herein provide methods and systems that determine accepted flying rules for a specific region along an ownship flight path based on the context of the region as well as the current conditions prevailing in the region. The systems and methods disclose forward displays or apps to pilots so that the pilot can quickly decide and plan the flying rules for an entire flight path. Further, an efficiency factor for the flying conditions may be determined and displayed. The efficiency factor may be provided in three categories: safety, fuel and time.

In embodiments, the flight rules are determined based on conditions data received from a variety of sources. One example of conditions data is visibility data (IMC), which may be received by from air-to-air and/or ground-to-air broadcasts and/or satellite-to-air, e.g. from other aircraft and/or from ground stations. One example of visibility data is that provided through Airmen's Meteorological Information (AIRMET). Visibility data could also be derived from onboard sensors such as a particle sensor. Another example of conditions data is cloud ceilings data received from a variety of sources including air-to-air, ground-to-air and. or satellite-to-air broadcasts. Cloud ceilings may also be determined from on-board sensors such as Radar. Existing meteorological data providers, such as Airmet, provide data covering moderate turbulence, moderate icing, sustained surface winds of 30 knots or more, widespread areas of ceilings less than 1,000 feet and/or visibility less than three miles, and extensive mountain obscurement. Further Airmet includes a weather advisory issued by a meteorological watch office for aircraft that is potentially hazardous to low-level aircraft and/or aircraft with limited capability. The aircraft systems described herein may support FIS-B services provided by the Federal Aviation Authority (FAA) utilizing the 978 MHz Universal Access Transceivers (UAT).

In embodiments, an alert to flight crew is output in advance when the conditions are Instrument Meteorological Conditions (IMC), which helps flight crew in decision making and eliminating risk. An algorithm is disclosed that warns a Visual Flight Rules (VFR) pilot about approaching IMC conditions.

In one exemplary method, a flight plan is received as an input. The flight plan can be received from onboard systems of an ownship (e.g. from the Flight Management System (FMS)). The system determines guidance for flying rules based on the flight plan and conditions data. Flying regions are determined for the flight plan. The conditions data in the flying regions is analyzed. The conditions data includes any clearances issued to the air traffic operating in that region, weather patterns and the forecast changes to weather in that region, specific restrictions enforced in that region by analyzing Notices To AirMen (NOTAMs), navigation procedures available in that region, identify flying rules followed by traffic aircraft flying in that region which may or not be similar to ownship aircraft type specification, terrain information available on the region, Automatic Terminal Information Service (ATIS) or Digital ATIS information available for the region, and/or Pilot Information Reports (PIREPs). The flying rules are determined for each of the regions for the flight plan based on the conditions data. The flying rules may be updated through a flight along a flight plan as new and updated conditions data is received. When the flying rules change as a result of the update to the conditions data, an alert will be output. The alert will include information on the new flying rules and may include a prompt for the pilot to take any system action required to change to the updated flying rules for a given flying region. A rating in three categories may be determined based on any flight plan changes required by predicted flight rules and based on the flight rules changes themselves. The three categories include fuel efficiency, time, and safety. The optional rating information and the determined flight rules are provided to cockpit display or other output systems or apps that would output the information.

The exemplary systems described herein can include an analysis system and an assistance system. The analysis system can continuously monitor changes for all flying regions based on crowd soured data from different systems like NOTAM, ATIS, Clearances, Weather Systems and/or Airport Systems. The crowd sourced data may be broadcast from other aircraft, from a ground station and/or from a satellite. The crowd sourced data may include data from relevant onboard sensors of the ownship. The assistance system receives the flight plan from the cockpit and invokes the analysis system to come up with recommendations to output assistance for flying the various flying regions along the flight plan.

In another exemplary method, an active flight plan is received. The active flight plan includes an origin, a destination and intermediate waypoints. The flight plan can be received from the FMS. Weather and other conditions data reports are received for each flight plan leg from various sources. The conditions data can include data from PIREPs, ATIS, NOTAMs, METeorological Aerodrome Reports (METARs), Aviation Selected Special Weather Report (SPECI), AIRMET, Significant Meteorological Information (SIGMET), controller clearances, connected weather, etc. The conditions data is analyzed for any potential hazards with respect to IMCs that impacts the active flight plan. When conditions for IMC exist and the current flight rules are different, an alert or advisory is output regarding the change of flight rules in real time in the crew interface and indicators are displayed. When conditions for IMC exist do not exist and the current flight rules are different, no action is taken. That is, when the flight rules are not changed as a result of received conditions, no output or alert is provided. The indicators can include a color coded safety indicator symbology when there is a difference in actual flight rules versus required flight rules. The safety indicator is maintained as long as crew has not yet acknowledged and filed an IFR. Doing so may include requesting pop-up IFR clearance from Air Traffic Control (ATC) and submitting an instrument flight plan to the FMS in response to information received from ATC. Alternatively, an instrument flight plan may already be active and the flight crew merely needs to acknowledge the change in behavior required to transition from VMCs to IMCs. The safety indicator may change color such as from red to green once the change to IFR has been made, e.g. acknowledged by input to the cockpit system or submitted by filing pop-up clearance and an instrument flight plan. Any flight plan change based on the change in weather or based on requirements from ATC resulting from the change from VMC to IMC may impact on fuel and time. Corresponding indicators may be provided to alert whether fuel or time efficiency has been lost or gained. The fuel and time indicators may be set based on a difference in the Estimated time of Arrival (ETA) and fuel required data from the FMS performance and prediction function.

In one use case, IMCs have been determined by the system but the pilot is approaching a flying region under VFR. The system provides an advisory alert about the IMC conditions and suggests to change to IFR. In this case, a safety indictor is red (for example). When the pilot changes to IFR, the safety indicator changes to green (for example). The change in flying rules may require a flight plan change, which will impact other parameters. As another use case, the flight crew change the flight plan due to a weather hazard that also results in a change in flight rules. The weather conditions may necessitate not only a change from VFR to IFR but also a detour around a weather pattern. As a result, an estimated time of arrival (ETA) and fuel required will change and fuel and time indicators will be output according to the change. The change in flight plan may not necessarily harm fuel and time efficiency considerations, in which case different color coding or other symbol changes could be provided depending on impact on fuel and time efficiency for any in-flight changes to the flight plan as a result of the conditions data and changing flight rules. The FMS can provide fuel and time change predictions for a given flight plan change. In another use case, when the conditions are deteriorating and the flight crew is approaching in VFR, the Pilot could change the runway or airport if an IFR cannot be filed, which will result in a flight plan change as a result of an alert concerning flying rules.

In some embodiments, the alert includes details of IMCs in each flying region as determined by the system such as altitude range for the IMCs. The alert concerning current flying rules and time/location of change of flying rules can be provided on a lateral and/or vertical map display. The flying regions can be defined as a volume of airspace between way points (position and altitude) in a flight plan. That is, a volume of airspace associated with each flight leg.

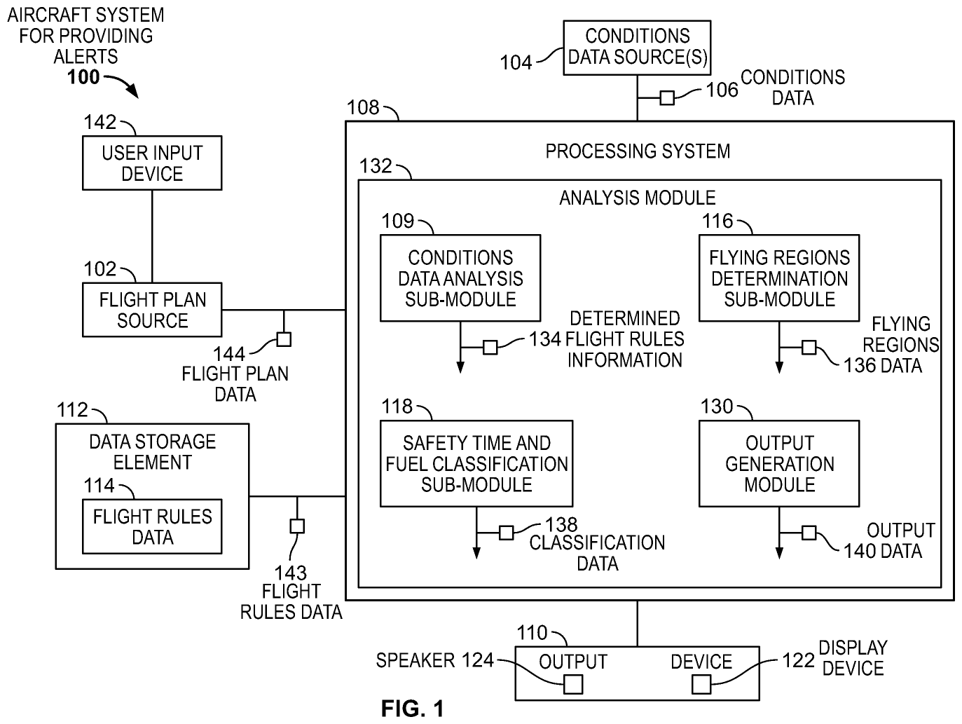

FIG. 1 depicts an exemplary embodiment of an aircraft system 100 suitable for alerting flight crew of any changes in flight rules during flight. The illustrated system 100 includes a flight plan source 102 and a conditions data source 104 coupled to a processing system 108 that implements, executes, or otherwise supports an analysis module 132 that derives changes in flight rules from conditions data 106 and outputs alerts of any changes in the flight rules, particularly a change from VFRs to IFRs in any given flying region. It should be appreciated that FIG. 1 is a simplified representation of an aircraft system 100 for purposes of explanation and not intended to limit the subject matter in any way. In this regard, it will be appreciated that in practice, an aircraft system 100 onboard an aircraft may include any number of different onboard systems configured to support operation of the aircraft, and the subject matter described herein is not limited to any particular type or number of onboard systems.

The conditions data source(s) 104 includes any one or more providers of data relevant to an assessment of flight rules particularly data relating to visibility and clouds. In particular, the data should be relevant to whether VMCs or IMCs exist in a given flying region. The conditions data source(s) can include NOTAMs, ATIS, weather broadcasts and controller clearances. Any combination of these conditions data source(s) 104 may be provided including two, three or all four thereof. Additional or alternative conditions data source(s) 104 include one or more of AIRMET, PIREPs, Automatic Dependent Surveillance Broadcasts (ADS-B), particularly with respect to the flying rules operated by other aircraft and terrain data. A crowd sourced combination of such conditions data source(s) 104 may be used to call the conditions data 106 to project visibility, cloud coverage and other pertinent data that includes both current and projected data along a flight path of the ownship aircraft. The conditions data source(s) 104 may be realized by remote data source(s) or device(s) that are communicatively coupled to the processing system 108 via a communications network or by broadcast communications. The condition data source(s) 104 may include data broadcast communications via satellite, from ground stations or from other aircraft.

In exemplary embodiments, the data storage element 112 stores or otherwise maintains flight rules data 114 describing Visual meteorological conditions (VMCs), which are conditions under which VFR flight are permitted in a certain airspace. The boundary criteria between VMC and instrumental meteorological conditions (IMCs) is given by VMC minima, which may be defined by parameters that may include one or more visibility parameters (e.g., flight visibility, and whether or not the surface is in sight) and one or more cloud distance parameters (e.g., vertical cloud distance, horizontal cloud distance, and whether or not there is clearance of clouds). As such, the flight rules data 114 relating to VMCs implicitly defines IMCs. These parameters may vary depending on the region or country.

For example, the International Civil Aviation Organization (ICAO) has adopted a set of classifications for airspace, comprising classes A through G. Each class of airspace is associated with VMC minima defined in terms of parameters such as minimum visibility and minimum distance from clouds. That is, a minimum visibility and a minimum distance from clouds is specified for various combinations of airspace class and altitude band. The Federal Aviation Authority (FAA) has adopted its own set of rules for VMC minima, as generally set out in Table 1 below.

TABLE 1

| Basic VFR Weather Minimums | | | | |
|---|---|---|---|---|
| Airspace | | | Flight Visibility | Distance from Clouds |
| Class A | | | Not applicable | Not applicable |
| Class B | | | 3 statute miles | Clear of clouds |
| Class C | | | 3 statute miles | 1,000 feet above |
| | | | | 500 feet below |
| | | | | 2,000 feet horizontal |
| Class D | | | 3 statute miles | 1,000 feet above |
| | | | | 500 feet below |
| | | | | 2,000 feet horizontal |
| Class E | At or above 10,000 feet MSL | | 5 statute miles | 1,000 feet above |
| | | | | 1,000 feet below |
| | | | | 1 statute mile horizontal |
| | Less than 10,000 feet MSL | | 3 statute miles | 1,000 feet above |
| | | | | 500 feet below |
| | | | | 2,000 feet horizontal |
| Class G | 1,200 feet or | Day, except as | 1 statute mile | Clear of clouds |
| | less above the | provided in | | |
| | surface | section 91.155(b) | | |
| | (regardless | Night, except as | 3 statute miles | 1,000 feet above |
| | of MSL altitude). | provided in | | 500 feet below |
| | | section 91.155(b) | | 2,000 feet horizontal |
| | More than | Day | 1 statute mile | 1,000 feet above |
| | 1,200 feet | | | 500 feet below |
| | above the | | | 2,000 feet horizontal |
| | surface but | Night | 3 statute miles | 1,000 feet above |
| | less than | | | 500 feet below |
| | 10,000 feet | | | 2,000 feet horizontal |
| | MSL. | | | |
| | More than | | 5 statute miles | |
| | 1,200 feet | | | |
| | above the | | | |
| | surface and | | | |
| | at or above | | | |
| | 10,000 feet | | | |
| | MSL. | | | |

For example, if an aircraft is flying in a class E airspace, and is at an altitude of 15,000 feet above mean sea level (MSL), the aircraft may fly under VFR if the flight visibility is 8 km (5 miles) or greater, and the distance from clouds is 1 mile or greater horizontally and 1000 feet or greater vertically. If the flight visibility is only 5 km (3 miles), then VFR flight is not permitted under the rules specified. It should be appreciated that the information in Table 1 is subject to change and thus is non-limiting.

In general, the VMC minima that is applicable to an aircraft may depend on parameters such as the class of the airspace in which the aircraft is traveling and the altitude band in which the aircraft is traveling (which may be defined by parameter such as above mean sea level (MSL) and distance above terrain). Depending on the region or country, the VMC minima may also depend on other factors, such as the time of day (e.g., daytime or nighttime), the type of aircraft (e.g., airplane or helicopter), and/or the speed of the aircraft.

The above table is provided to illustrate that different combinations of airspace class and altitude bands may have different respective VMC minima. As noted above, national aviation authorities may differ in their specific implementations of the ICAO airspace classes. For example, in some countries, there is also class F airspace and the cloud condition for class B differs.

In embodiments, the VMC and IMC conditions are defined in flight rules data 114 included in data storage element 112. The flight rules data 114 may relate airspace class, flight visibility, distance from clouds and other conditions for defining whether VFR is permitted. The flight rules data 114 may be provided for each country, region or jurisdiction where the flight rules differ. The systems described herein will select the appropriate flight rules depending on location (projected or current) of the aircraft. Although VFR and IFR has been highlighted in the present section of the description, there are other categories of flight rules including Low Instrument Flight Rules (LIFR) when the cloud ceiling is below 500 feet and/or the visibility is less than 1 mile and Marginal Flight Rules when the cloud ceiling is 1000 to 3000 feet and/or the visibility is 3 to 5 miles. Such categories or types of flight rules could be incorporated into detailed flight rules data 114 to allow a system to assess predicted conditions, as derived from conditions data 106, with respect to the flight rules data 114 to classify flight regions as to flight rules that will be in place for that flight region. Further, the time when flight rules will change can be projected.

In the example of FIG. 1, the aircraft system 100 includes a flight plan source 102. The flight plan source 102 can be an FMS. An FMS is a specialized computer system that automates a wide variety of in-flight tasks, reducing the workload on the flight crew. A primary function is in-flight management of the flight plan. Using various sensors (such as GPS and INS often backed up by radio navigation) to determine the aircraft's position, the FMS can guide the aircraft along the flight plan. A user input device 142 allows the flight crew to enter data and make selections relating at least to the flight plan. The user input device 142 further allows the user to acknowledge any change in flight rules and to enter an instrument flight plan in response to an alert that flight rules are changing from VFR to IFR.

The flight management system can be configured to implement one or more flight mode(s), flight plans, etc. of the aircraft of the aircraft system 100 selected by user input and display information associated with the one or more flight mode(s) on the one or more display devices 122. In embodiments, a navigation function of the flight management system allows a route to be programmed by a user through the user input device 142. A flight director (not shown) and an auto-pilot system (not shown) can steer the aircraft along the desired course to an active waypoint. When the aircraft reaches an active waypoint, the flight management system automatically sequences to the next waypoint in the route, unless waypoint sequencing is suspended. The flight management system, which may be the flight plan source 102, outputs flight plan data 144 defining waypoints between an origin and a destination making up a flight plan for the aircraft. Each flight leg between neighboring waypoints may be referred to as flying regions herein. The waypoints are specified in terms of altitude, latitude and longitude. A different level of detail of flight plan may be used depending on whether VFRs or IFRs are in place. An instrument flight plan must be more meticulously defined to allow for instrument only navigation. When a flight changes from VFRs to IFRs mid-flight, pop-up ATC clearance may be required and an instrument flight plan may need to be entered to the flight plan source 102 through the user input device 142 and filed with ATC during flight.

In embodiments, the user input device 142 is located in the cockpit and provides input to one or more system(s) of the aircraft system 100. The user input device 142 includes any device suitable to accept input from a user for interaction with the aircraft system 100. For example, the user input device 142 includes one or more of a keyboard, joystick, multi-way rocker switches, mouse, trackball, touch screen, touch pad, data entry keys, a microphone suitable for voice recognition, and/or any other suitable device. The user input device 142 allows the user to interact with a graphic and/or textual data element provided for display on the one or more display devices 122.

Although not illustrated in FIG. 1, the aircraft system 100 includes other onboard system(s) representing any sort of electrical, mechanical, hydraulic, pneumatic, environmental, or propulsion systems configured to provide information or data that characterizes or is otherwise indicative of a current operational status of the vehicle. For example, in the case of an aircraft, the onboard systems could include or otherwise be realized as any one or more of the following: a flight management system (FMS), a communications system, a navigational system, a weather system, a radar system, an autopilot system, an autothrust system, a landing gear system, a flight control system, hydraulics systems, pneumatics systems, environmental systems, aircraft systems, engine systems, trim systems and/or another avionics system. As described in greater detail below, the processing system 108 is coupled to the onboard system(s) to obtain information indicative of the current operational status of the aircraft, such as, for example, the current flight phase, the current altitude, the current aircraft configuration, the current meteorological conditions, and/or other operating conditions that may influence the prevailing or predicted flight rules for each flying region.

In exemplary embodiments, the output device 110 includes one or more electronic display devices 122 onboard the aircraft for presenting data and/or information to the flight crew. In exemplary embodiments, a display device 122 is coupled to the processing system 108, with the processing system 108 and/or the analysis module 132 providing output data 140 embodying a graphical alert to be displayed. Additionally, in some embodiments, the output device 110 may include a speaker or other audio output device that may be utilized by the processing system 108 and/or the analysis module 132 to provide an auditory indication of an alert regarding flight rules. In embodiments, the alert includes a prediction of when and where flight rules will change and a description of the type of flight rules between which the change will happen.

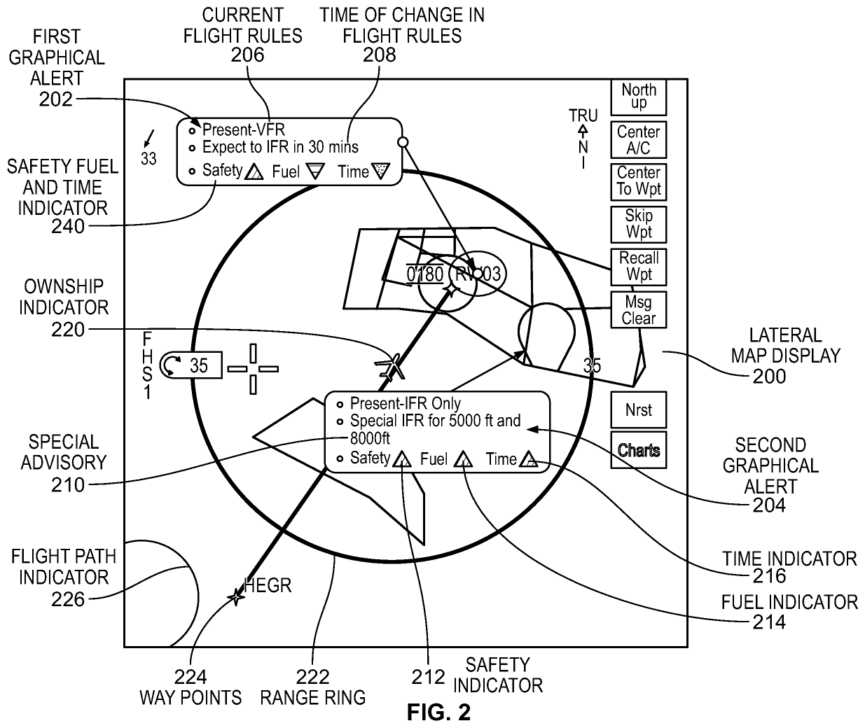

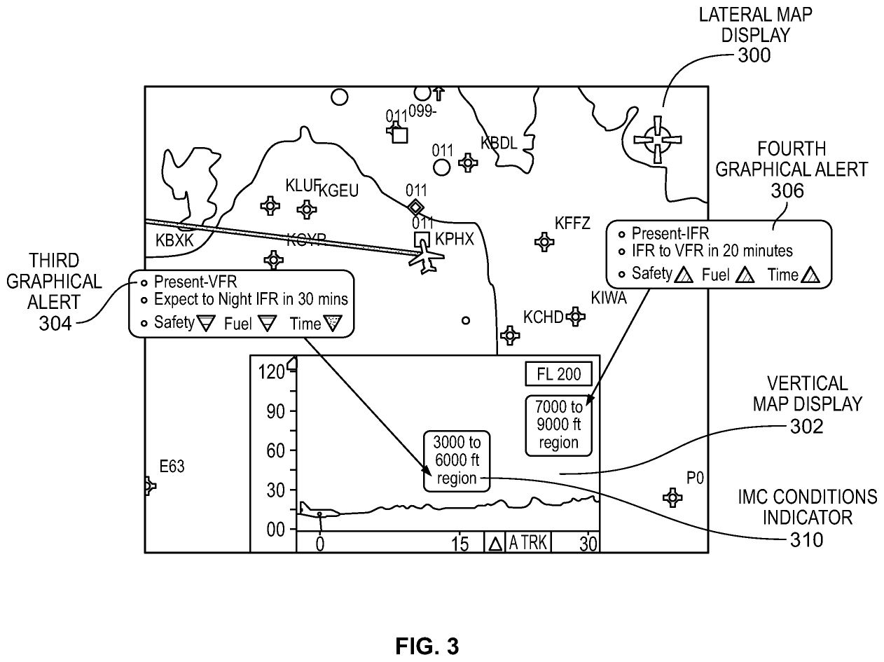

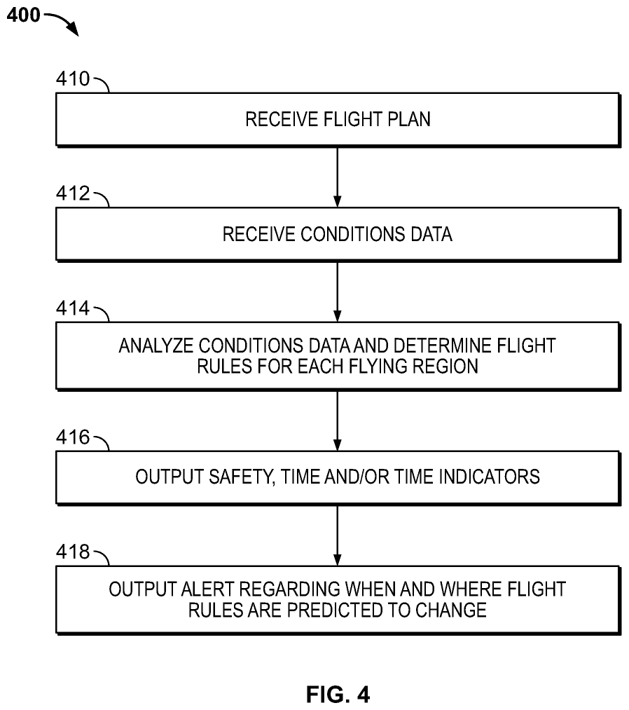

The processing system 108 generally represents the hardware, software, and/or firmware components (or a combination thereof), which is communicatively coupled to the various elements of the system 100 and configured to support the flight rules alert generation functions described herein, particularly with respect to exemplary graphical alerts of FIGS. 2 and 3 and the method 400 of FIG. 4. Depending on the embodiment, the processing system 108 may be implemented or realized with a general-purpose processor, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. The processing system 108 may also be implemented as a combination of computing devices, e.g., a plurality of processing cores, a combination of a digital signal processor and a microprocessor, a plurality of microprocessors, one or more microprocessors in conjunction with a digital signal processor core, or any other such configuration. In practice, the processing system 108 may include processing logic that may be configured to carry out the functions, techniques, and processing tasks associated with the operation of the system 100, as described in greater detail below. Furthermore, the steps of a method or algorithm described in connection with the embodiments disclosed herein may be embodied directly in hardware, in firmware, in a software module executed by the processing system 108, or in any practical combination thereof. In the illustrated embodiment, the processing system 108 includes or otherwise accesses the data storage element 112 (or memory) capable of storing code or other computer-executable programming instructions that, when read and executed by the processing system 108, cause the processing system 108 to generate, implement, or otherwise execute the analysis module 132 that supports or otherwise performs certain tasks, operations, functions, and/or processes described herein.

The data storage element 112 generally represents any sort of non-transitory short- or long-term storage media capable of storing code, computer-executable programming instructions, and/or other data. Depending on the embodiment, the data storage element 112 may include or otherwise be physically realized using random access memory (RAM), read only memory (ROM), flash memory, registers, a hard disk, or another suitable data storage medium known in the art or any suitable combination thereof. Moreover, in some embodiments, the data storage element 112 may be realized as a database or some other remote data storage or device that is communicatively coupled to the processing system 108 via a communications network. In such embodiments, data maintained at the data storage element 112 may be downloaded or otherwise retrieved by the processing system 108 and stored locally at the processing system 108 or an onboard data storage element.

The processing system 108, particularly the analysis module 132, receives and processes the conditions data 106, the flight plan data 144 and the flight rules data 143. That is, the operating flight rules at each leg or flying region of the flight plan are determined based on the conditions data 106. The conditions data 106 may include, or may be need to be, projected into the future so that the prevailing conditions at the projected time of arrival of the aircraft at each flying region are utilized to determine the flying rules. Visibility and cloud data are primary data points in assessing the flying rules but terrain, ATC, flying rules data from other aircraft and other data attributes can be analyzed by the processing system 108 to predict the flying rules in each flying region along a flight plan. Accordingly, the flying rules along a flight plan can be determined and any changes in flying rules can be predicted. The pilot can be given an advance warning via an alert as to when and where the flying rules change will occur. Specifically, a graphical alert may be provided via the display device 122 as discussed further below with respect to FIGS. 2 and 3.

In embodiments, the analysis module 132 includes a flying regions determination sub-module 116 for dividing a flight plan (embodied by flight plan data 144) into flying regions. In one embodiment, the flying regions correspond to flight legs defined in the flight plan data 144. However, other ways to divide a flight plan are possible. For example, a VFR flight plan may not sufficiently divide a flight path into many flight legs. In such a case, another flying region division scheme could be implemented, such as by making each flying region a certain length along the flight plan. In some embodiments, the flying regions may be more densely defined in takeoff and climbing phases of flight and in descending and landing phases of flight than in cruise phase of flight. The flying regions determination sub-module 116 thus outputs flying regions data 136.

The conditions data analysis sub-module 109 receives the flying regions data 136 and the conditions data 106. The flying conditions described in the conditions data 106 are analyzed for each flying region defined in the flying regions data 136 with respect to the flight rules data 114. Predicted flying conditions are optimally used to align the likely flying conditions at the time of the aircraft passing through each flying region. The conditions data analysis sub-module 109 is thus able to predict the prevailing flying regions at each flying region for each time of arrival at the flying region and to associate flying rules with each flying region. The conditions data analysis sub-module 109 can output determined flight rules information 134, which describes flight rules associated with each flying region along a flight plan.

The output generation sub-module 130 generates an alert based on the determined flight rules information 134. In one embodiment, the determined flight rules information 134 can be evaluated for changes in flight rules from one flying region to another and/or changes caused by updated or new conditions data 106. When such a change is found, a graphical and/or aural alert may be output through the output device 110, specifically the display device 122 and the speaker 124, respectively. The alert can indicate the flight rules in place before the change and the flight rules in place after the change and also provide a numerical or symbolical indication of a time until the change. Further, the output generation sub-module 130 may provide a safety, fuel and time indication associated with any changes in the flight plan as a result of the change in flight rules.

In one embodiment, a safety indicator is output when a flight rules change from VFR to IFR is evaluated by the output generation sub-module 130. The safety indicator, which will be described further below, serves an indicator to the flight crew as to whether action needs to be taken regarding the change of flight rules. When an in-air change to IFR is to be made, the crew should establish the communication with ATC requesting clearance to change to IFR. Further, an instrument flight plan may be entered to the FMS via the input device, which is submitted to ATC over a datalink. The output generation sub-module 130 may change the safety indicator from symbology indicating that action needs to be taken to symbology indicating that the requisite action has been taken. The output generation sub-module 130 may change the symbology in response to a pilot acknowledgement and confirmation of having carried out the necessary actions through the user input device 142. Alternatively, the output generation sub-module 130 may interpret communications from ATC and/or data from the FMS to determine if the requisite actions have been taken.

In embodiments, the output generation sub-module 130 outputs time and/or fuel efficiency indicators relating to any change in flight plan associated with the change in flight rules. When an instrument flight plan is submitted in response to a change to IFR, a different route may be taken than was previously planned. A prediction function in the FMS allows the relative fuel and time gains or losses as a result of the replacement flight plan to be calculated. The output generation sub-module 130 receives the time and fuel efficiency data from the FMS and generates time and/or fuel indicators based thereon. The fuel and time efficiency indicators may be provided based on other flight plan changes. For example, when a pilot operating under VFR is notified of IMC conditions via the alert but does not have IFR capability, a flight plan avoiding the hazardous weather may be devised and entered to the FMS, which can provide consequent time and fuel change data for output by the output generation sub-module 130.

The output generation sub-module 130 outputs output data 140 embodying the alert of a change in flight rules and any safety, fuel and/or time indications. The output device 110 receives the output data 140 and outputs the corresponding alerts and indications.

FIG. 2 depicts an exemplary graphical user interface outputting an alert as generated by the processing system 108 described herein. FIG. 2 is disclosed in the context of a lateral map display 200 but other map displays and other types of displays (including non-map graphical displays) could be provided. The alert could also, or alternatively, be output as an aural alert. The lateral map display 200 includes an ownship indicator 220, a flight path indicator 226, waypoint indicators 224 and a range ring 222. The lateral map display 200 further includes one or more graphical map depictions, which in the present embodiment includes airport features such as runways, taxiways and buildings. The graphical map depictions may include terrain and ocean depictions depending on the location of map being displayed. The lateral map display 200 is generated based on, inter alia, map data from one or more databases and information from the FMS concerning the flight plan and the location of the ownship along the flight plan. The example of FIG. 2 depicts two possible graphical alerts 202, 204 as examples of the output of the analysis module 132. A first graphical alert 202 includes a current flight rules indicator 206, a next flight rules indicator 230 and a time of change of flight rules indicator 208. In the present embodiment, the analysis module 132 has determined that the flight rules are presently VFR and will change to IFR at a location along the flight plan that is 30 minutes away (based on projected speed and flight path). The first graphical alert 202 includes text describing the current flight rules, text describing next flight rules and alphanumeric text describing the time at which the flight rules will change. In the present example, the time is a countdown time relative to present time but absolute time could also be used. Although the first graphical alert 202 is textual in the present embodiment, symbology to represent the various indicators may be used instead. In the illustrated example, the first graphical alert 202 includes a safety, fuel and/or time indicator 240. In the present example, the safety part of the indicator 240 is indicating to the pilot that no action needs to be taken as the flight crew or the system has taken action to submit the instrument flight plan in preparation for the change from VFR. The safety part of the indicator 240 may be color-coded or shaped or directed to communicate that no further action is required by the flight crew. This may also be communicated in a textual message. The fuel and time parts of the indicator 240 indicate that fuel and time efficiency has been lost as a result of the change in flight plan required by the change to IFR and may be color coded, directed, shaped or worded to communicate such. In the example second graphical alert 204, there is a message that IFR only are allowed and the safety, fuel and/or time indicators are set (e.g. through color coding, shape, etc.) to communicate that the instrument flight plan and other actions for an IFR only flight plan have been taken. Further, fuel and time efficiency has not been lost under the IFR flight plan. The second graphical alert 204 further includes a special advisory 210, which details any special rules being allowed by the ATC as part of the flight plan. In the present case, VFR is permitted at 5000 feet and 8000 feet even though the aircraft should usually be operating under IFR as part of a special dispensation from ATC. This special advisory 210 concerning any special flight rules permitted by ATC could be derived from ATC communications or from data from the FMS.

FIG. 3 depicts another exemplary graphical user interface outputting an alert as generated by the processing system 108 described herein. FIG. 3 is disclosed in the context of a lateral map display 300 and a vertical map display 302 presented adjacent to one another. However, the vertical map display 302 may be presented independent of the lateral map display 300. Further, the alert may be included in a non-map graphical display. In the present example, the graphical alert is included in the vertical map display 302, which depicts an ownship indicator, a flight path and terrain features in a vertical profile view. In one example, a third graphical alert 304 is provided, which includes a current flight rules indicator (Present—VFR) and a next flight rules indicator (Expect to Night IFR) and a time of change of flight rules indicator (30 mins) Further, the third graphical alert 304 includes a safety, fuel and/or time indicator, which indicates that action needs to be taken to submit an instrument flight plan to ATC and the FMS and that the change in flight plan is likely to be increase fuel and time costs. The safety indicator may be provided without the fuel and time indicators and serves as a prompt to the flight crew to take action to convert from VFR to night IFR. In the example of the fourth graphical alert 306, there is an indication that change to IFR will occur in 20 minutes. The safety, fuel and/or time indicator of the fourth graphical alert 306 indicates that no (further) action is required by the flight crew to implement the flight rules change and that fuel and/or time efficiency is not being lost. In the example of FIG. 3, there is also an IMC conditions indicator 310 indicating IMC conditions determined by the conditions data analysis sub-module 109 by assessing the flight conditions data 106 relative to the flight rules data 143. The IMC conditions indicator 310 provides an indication of the prevailing external environmental conditions causing the change in flight rules. In the present example, the change to night IFR is indicated to be caused by IMCs in the 5000 to 6000 feet region. In another example, the change to VFR is caused by IMCs in the 7000 to 9000 feet region.

A flow chart of an exemplary method 400 of generating alerts relating to flight rules is provided in FIG. 4. The method 400 is computer implemented by the processing system 108 of FIG. 1, specifically by the analysis module 132 of FIG. 1. The method includes step 410 of receiving a flight plan, which includes waypoints and flying regions extending between waypoints. The flight plan may be provided by the FMS or other flight plan source 102 and is generated based on user selections through user input device 142. The method 400 includes step 412 by which conditions data 412 is received. The conditions data 412 can be received from multiple conditions data source(s) and may include weather data for each flying region, particularly in relation to visibility at flying regions along the flight plan and cloud coverage. The conditions data source(s) include ATIS, NOTAMs, METAR, SPECI, AIRMET, and SIGMENT, etc. as non-limiting examples. The conditions data 412 may be received pre-flight and in-flight. The conditions data may be received from ground, satellite or aircraft to aircraft broadcasts. Generally, the conditions data 412 are received and evaluated in-flight.

The method 400 includes a step 414 of analyzing the conditions data 106 with respect to IMCs included in the flight rules data 143 so as to determine whether flight rules along the flight plan are predicted to be required to change as a result of the projected prevailing conditions at each flying region along the flight path. The method 400 may be repeated throughout a flight so that the flying rules are continually assessed as the flight progresses. The method 400 may be invoked each time new conditions data 106 is received or at predetermined intervals. When the analysis step 414 determines that flying rules are to be changed at any flying region (such as a change to IFRs), the method continues to steps 416 and 418. If not change in flying rules is determined, then no further actions is taken.

In step 416, safety, time and/or time indicators are output. It should be appreciated that method 400 may exclude step 416. When step 414 determines that a change in flight rules is required, and when that change in flight rules requires pilot action, a safety indicator or other prompt is output to the flight crew by the output device 110. The safety indicator may be a graphical and/or aural flag. The processing system 108 monitors pilot inputs via user input device 142, communications with ATC and/or data from the FMS to detect whether the flight crew has submitted an instrument flight plan to the FMS and the ATC or other action that is required as a result of the flight rules change. If not, the safety indicator is maintained. If so, the safety indicator changes status to indicate that no further action is required in changing the flight rules. If the pilot action results in a change of flight plan, the time and/or fuel efficiency indicators are output to indicate a change in fuel and/or time costs as a result of the replacement flight plan. This information is available from a prediction function in the FMS.

In step 418, the alert is output indicating when and where each flight rules are predicted to change. The alert can include an aural and/or graphical message as to the current flight rules, the next flight rules and a time until the change between flight rules.

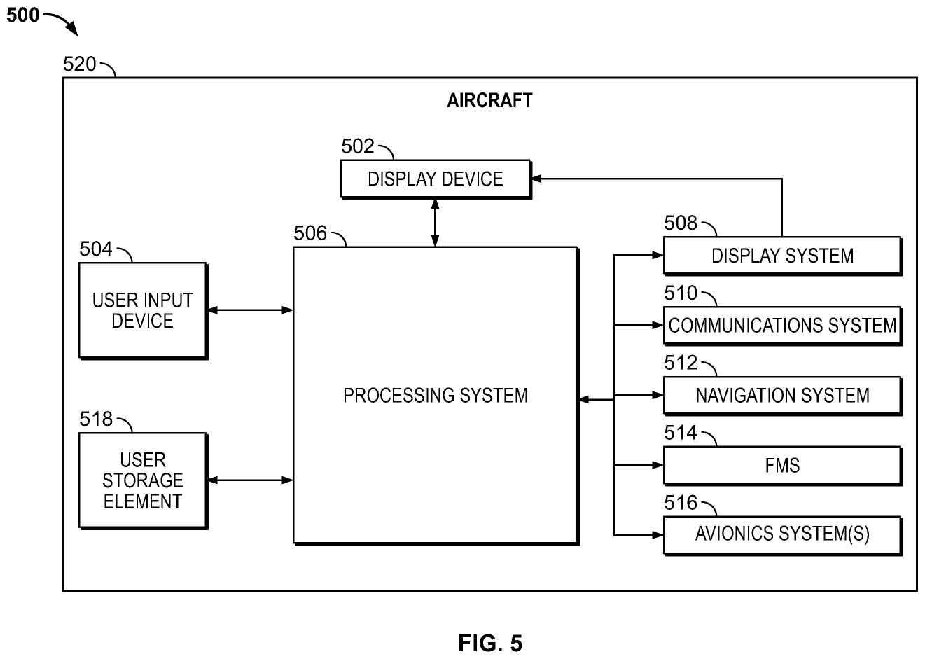

FIG. 5 depicts an exemplary embodiment of an aircraft system 500 suitable for implementing the flight rules alerts described herein. The illustrated aircraft system 500 (corresponding to aircraft system 100 of FIG. 1) includes, without limitation, a display device 502 (corresponding to display device 122 of FIG. 1), one or more user input devices 504 (corresponding to user input device 142 of FIG. 1), a processing system 506 (corresponding to processing system 108 of FIG. 1), a communications system 510, a navigation system 512, a flight management system (FMS) 514 (corresponding to the flight plan source 102 of FIG. 1), one or more avionics systems 516, and a data storage element 518 (corresponding to data storage element 112 of FIG. 1) suitably configured to support operation of the system 500.

In exemplary embodiments, the display device 502 is realized as an electronic display capable of graphically displaying flight information or other data associated with operation of the aircraft 520 under control of the display system 508 and/or processing system 506. In this regard, the display device 502 is coupled to the display system 508 and the processing system 506, wherein the processing system 506 and the display system 508 are cooperatively configured to display, render, or otherwise convey one or more graphical representations or images associated with operation of the aircraft 520 on the display device 502. The user input device 504 is coupled to the processing system 506, and the user input device 504 and the processing system 506 are cooperatively configured to allow a user (e.g., a pilot, co-pilot, or crew member) to interact with the display device 502 and/or other elements of the system 500, as described herein. Depending on the embodiment, the user input device(s) 504 may be realized as a keypad, touchpad, keyboard, mouse, touch panel (or touchscreen), joystick, knob, line select key or another suitable device adapted to receive input from a user. In some embodiments, the user input device 504 includes or is realized as an audio input device, such as a microphone, audio transducer, audio sensor, or the like, that is adapted to allow a user to provide audio input to the system 500 in a “hands free” manner without requiring the user to move his or her hands, eyes and/or head to interact with the system 500.

The processing system 506 generally represents the hardware, software, and/or firmware components configured to facilitate communications and/or interaction between the elements of the aircraft system 500 and perform additional tasks and/or functions to support the analysis module 132 of FIG. 1 during operation of the aircraft system 500, as described herein. Depending on the embodiment, the processing system 506 may be implemented or realized with a general-purpose processor, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. The processing system 506 may also be implemented as a combination of computing devices, e.g., a plurality of processing cores, a combination of a digital signal processor and a microprocessor, a plurality of microprocessors, one or more microprocessors in conjunction with a digital signal processor core, or any other such configuration. In practice, the processing system 506 includes processing logic that may be configured to carry out the functions, techniques, and processing tasks associated with the operation of the aircraft system 500, as described herein. Furthermore, the steps of a method or algorithm described in connection with the embodiments disclosed herein may be embodied directly in hardware, in firmware, in a software module executed by the processing system 506, or in any practical combination thereof. For example, in one or more embodiments, the processing system 506 includes or otherwise accesses a data storage element 518 (or memory), which may be realized as any sort of non-transitory short- or long-term storage media capable of storing programming instructions for execution by the processing system 506. The code or other computer-executable programming instructions, when read and executed by the processing system 506, cause the processing system 506 to support or otherwise perform certain tasks, operations, and/or functions described herein in the context of the flight rules alerts. Depending on the embodiment, the data storage element 518 may be physically realized using RAM memory, ROM memory, flash memory, registers, a hard disk, or another suitable data storage medium known in the art or any suitable combination thereof.

The display system 508 generally represents the hardware, software, and/or firmware components configured to control the display and/or rendering of one or more navigational maps and/or other displays pertaining to operation of the aircraft 520 and/or onboard systems 510, 512, 514, 516 on the display device 502. In this regard, the display system 508 may access or include one or more databases suitably configured to support operations of the display system 508, such as, for example, a terrain database, an obstacle database, a navigational database, a geopolitical database, a terminal airspace database, a special use airspace database, or other information for rendering and/or displaying navigational maps and/or other content on the display device 502.

Still referring to FIG. 5, in an exemplary embodiment, the processing system 506 is coupled to the navigation system 512, which is configured to provide real-time navigational data and/or information regarding operation of the aircraft 520. The navigation system 512 may be realized as a global navigation satellite system (e.g., a global positioning system (GPS), a ground-based augmentation system (GBAS), a satellite-based augmentation system (SBAS), and/or the like), inertial reference system (IRS), or a radio-based navigation system (e.g., VHF omni-directional radio range (VOR) or long range aid to navigation (LORAN)), and may include one or more navigational radios or other sensors suitably configured to support operation of the navigation system 512, as will be appreciated in the art. The navigation system 512 is capable of obtaining and/or determining the instantaneous position of the aircraft 520, that is, the current (or instantaneous) location of the aircraft 520 (e.g., the current latitude and longitude) and the current (or instantaneous) altitude or above ground level for the aircraft 520. The navigation system 512 is also capable of obtaining or otherwise determining the heading of the aircraft 520 (i.e., the direction the aircraft is traveling in relative to some reference). In the illustrated embodiment, the processing system 506 is also coupled to the communications system 510, which is configured to support communications to and/or from the aircraft 520. For example, the communications system 510 may support communications between the aircraft 520 and air traffic control or another suitable command center or ground location. In this regard, the communications system 510 may be realized using a radio communication system and/or another suitable data link system.

In an exemplary embodiment, the processing system 506 is also coupled to the FMS 514, which is coupled to the navigation system 512, the communications system 510, and one or more additional avionics systems 516 to support navigation, flight planning, and other aircraft control functions in a conventional manner, as well as to provide real-time data and/or information regarding the operational status of the aircraft 520 to the processing system 506. Although FIG. 5 depicts a single avionics system 516, in practice, the aircraft system 500 and/or aircraft 520 will likely include numerous avionics systems for obtaining and/or providing real-time flight-related information that may be displayed on the display device 502 or otherwise provided to a user (e.g., a pilot, a co-pilot, or crew member). For example, practical embodiments of the aircraft system 500 and/or aircraft 520 will likely include one or more of the following avionics systems suitably configured to support operation of the aircraft 520: a weather system, an air traffic management system, a radar system, a traffic avoidance system, an autopilot system, an autothrust system, a flight control system, hydraulics systems, pneumatics systems, environmental systems, aircraft systems, engine systems, trim systems, lighting systems, crew alerting systems, electronic checklist systems, an electronic flight bag and/or another suitable avionics system. In various embodiments, the processing system 506 may obtain information pertaining to the current location and/or altitude of the aircraft 520 and/or other operational information characterizing or otherwise describing the current operational context or status of the aircraft 520 from one or more of the onboard systems 508, 510, 512, 514, 516.

It should be understood that FIG. 5 is a simplified representation of the aircraft system 500 for purposes of explanation and ease of description, and FIG. 5 is not intended to limit the application or scope of the subject matter described herein in any way. It should be appreciated that although FIG. 5 shows the various elements of the system 500 being located onboard the aircraft 520 (e.g., in the cockpit), in practice, one or more of the elements of the system 500 may be located outside the aircraft 520 (e.g., on the ground as part of an air traffic control center or another command center) and communicatively coupled to the remaining elements of the aircraft system 500 (e.g., via a data link and/or communications system 510). For example, in some embodiments, the data storage element 518 may be located outside the aircraft 520 and communicatively coupled to the processing system 506 via a data link and/or communications system 510. Furthermore, practical embodiments of the aircraft system 500 and/or aircraft 520 will include numerous other devices and components for providing additional functions and features, as will be appreciated in the art. In this regard, it will be appreciated that although FIG. 5 shows a single display device 502, in practice, additional display devices may be present onboard the aircraft 520. Additionally, it should be noted that in other embodiments, features and/or functionality of processing system 506 described herein can be implemented by or otherwise integrated with the features and/or functionality provided by the FMS 514. In other words, some embodiments may integrate the processing system 506 with the ′FMS 514. In yet other embodiments, various aspects of the subject matter described herein may be implemented by or at an electronic flight bag (EFB) or similar electronic device that is communicatively coupled to the processing system 506 and/or the ′FMS 514.

Referring to FIG. 5 with reference to FIG. 1, the processing system 506 and/or the FMS 514 may be configured to perform the flight rules Thus, the processing system 506 may be able to determined changes in flight rules based on predicted conditions along a flight path and to display alerts in association with a map or other display.

For the sake of brevity, conventional techniques related to sensors, statistics, data analysis, avionics systems, redundancy, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A system for providing alerts in an aircraft, the system comprising:
a flight plan interface for receiving a flight plan;
at least one data interface for receiving conditions data providing information on flight conditions along the flight plan including meteorological data; and
at least one processor in operable communication with the flight plan interface and the data interface, the at least one processor configured to execute program instructions, wherein the program instructions are configured to cause the at least one processor to:
analyze the conditions data in flying regions along the flight plan to determine flight rules information; and
outputting, to flight crew of the aircraft, an alert predicting when and where a change between type of flight rules will occur based on the flight rules information.

2. The system of claim 1, wherein the alert includes key information on the type of flying rule that has been derived in the analysis step.

3. The system of claim 1, wherein the analysis step determines at least one of safety, fuel and time metrics associated with the flying region based on the conditions data.

4. The system of claim 1, wherein the at least one of safety, fuel and time metrics include a plurality of levels and the alert includes a different indicator symbol to denote each level.

5. The system of claim 1, wherein the program instructions are configured to cause the at least one processor to share at least part of the flight rules information by externally transmitting at least part of the flight rules information.

6. The system of claim 1, wherein the analysis step includes analyzing the conditions data along the flight plan with respect to Instrument Meteorological Conditions (IMCs) and Visual Meteorological Conditions (VMCs) to determine whether Visual Flight Rules (VFRs) or Instrument Flight Rules (IFRs) apply at each of the flying regions.

7. The system of claim 1, wherein the at least one data interface receives conditions data from at least one of the following data sources: inbuilt weather radar, an Air Traffic Controller, other aircrafts, Automatic Terminal Information Service (ATIS), METeorological Aerodrome Reports (METARs), Pilot REPorts (PIREPs), and any offboard services.

8. The system of claim 1, wherein the alert includes an identification of a first type of flight rule before the change between type of flight rules and a second type of flight rule after the change between type of flight rules.

9. The system of claim 1, wherein the alert includes an indication of predicted time until the change between type of flight rules.

10. The system of claim 1, wherein the types of the flight rules include at least two of:
Visual Flight Rules (VFR);
Instrument Flight Rules (IFR);
Night VFR;
Night IFR;
Marginal VFR (MVFR); and
Low IFR (LIFR).

11. The system of claim 1, wherein the alert is output on a display device.

12. The system of claim 11, wherein the cockpit display device includes a lateral map display including a graphical depiction of at least part of the flight plan.

13. The system of claim 11, wherein the cockpit display device includes a vertical map display including a graphical depiction of at least part of the flight plan.

14. The system of claim 1, comprising analyzing the conditions data along the flight plan with respect to Instrument Meteorological Conditions (IMCs) to determine whether Instrument Flight Rules (IFRs) apply at each of the flying regions and displaying a warning safety indicator when flight rules change from Visual Flight Rules to Instrument Flight Rules (IFRs).

15. The system of claim 14, comprising ceasing the warning safety indicator in response to pilot and/or system confirmation of the change to IFRs.

16. A method for providing alerts in an aircraft, the method comprising:
receiving, via at least one processor, an active flight plan associated with a first set of flight rules;
receiving, in-flight and via the at least one processor, conditions data providing information on flight conditions along the flight plan including meteorological data; and
analyzing, in-flight and via the at least one processor, the conditions data in flying regions along the flight plan to determine flight rules information;
detecting, in-flight and via the at least one processor, a change in flight rules based on any updated flight rules in the flight rules information as compared to the first set of flight rules; and
in response to any updated flight rules being detected, outputting, via an output device associated with the aircraft, an alert to flight crew of the aircraft, the alert including a current type of flight rule for a flying region, an updated type of flight rule for the flying region and a time of change in the type of flight rule based on the flight rules information and the first set of flight rules.

17. The method of claim 16, wherein the analysis step determines at least one of safety, fuel and time metrics associated with the flying region based on the conditions data.

18. The method of claim 17, comprising displaying on a flight crew interface safety, time and/or fuel indicator symbology based on the at least one of safety, fuel and time metrics.

19. The method of claim 16, wherein the analysis step includes analyzing the conditions data along the flight plan with respect to Instrument Meteorological Conditions (IMCs) and Visual Meteorological Conditions (VMCs) to determine whether Visual Flight Rules (VFRs) or Instrument Flight Rules (IFRs) apply at each of the flying regions.

20. The method of claim 16, wherein the alert includes an identification of a first type of flight rule before the change between type of flight rules and a second type of flight rule after the change between type of flight rules.
